(19) United States
(12) Patent Application Publication
(10) Pub. No.: US 2023/0000011 A1
(43) Pub. Date: Jan. 5, 2023

(54) STRING TRIMMER ASSEMBLY AND TRIMMER HEAD FOR USE WITH SAME

(71) Applicant: MILWAUKEE ELECTRIC TOOL CORPORATION, Brookfield, WI (US)

(72) Inventors: Beth E. Cholst, Wauwatosa, WI (US); Mackenzie J. Nick, Theresa, WI (US)

(21) Appl. No.: 17/855,217

(22) Filed: Jun. 30, 2022

Related U.S. Application Data
(60) Provisional application No. 63/216,932, filed on Jun. 30, 2021.

(51) Int. Cl. A01D 34/416

(52) U.S. Cl. CPC A01D 34/4166; A01D 34/4165; A01D 34/4163

(57) ABSTRACT

A string trimmer assembly includes a trimmer head rotatably driven by a drive shaft and defining a cavity, a spool supported in the cavity of the trimmer head and operable to support line to be dispensed, and a flange formed on the spool. The spool includes a through hole for receiving the line, which is dispensable though an opening in the trimmer head. The flange is formed on the spool in a common plane with the opening and with the through hole. The flange separates the line into a first line portion and a second line portion. The first line portion is positioned on a first side of the flange, and the second line portion is positioned on a second side of the flange.

### CROSS-REFERENCE TO RELATED APPLICATIONS

This application claims priority to U.S. Provisional Patent Application No. 63/216,932, filed Jun. 30, 2021, the entire contents of which are incorporated herein by reference.

### FIELD

The present disclosure relates to trimmers. More particularly, the present disclosure relates to accessories for a string trimmer head.

### BACKGROUND

Generally, trimmers are used to cut grass and weeds and are often used to edge around trees, near fences and walls, and along landscape borders. Conventional string trimmers include an elongated shaft with a rotating element or head near the end of the elongated shaft, and a spool or string head is attached to the gear head. Typically, the string head includes a monofilament line (i.e., trimmer/cutting line) rotated by the head for cutting and trimming along landscaped areas, fences, walls, etc.

Such line is wrapped around a spool and may be dispensed from the string head during a cutting operation, in which the line is often broken or shortened due to obstructions (e.g., fence, stone, pavement, etc.) in a cutting region of the line. More line may be selectively dispensed from the string head until an amount of line on the spool is depleted or an error occurs during a line dispensing process. For example, the line may become blocked, stuck, or the like. During these occurrences, maintenance may be done on the string head to enable the dispensing process.

Often times, spools are also re-Tillable such that, once the among of cutting line is fully depleted, a new cutting line may be wrapped around the spool. An exemplary re-Tillable spool typically includes a single chamber for receiving the cutting line.

### SUMMARY

The present disclosure provides, in one aspect, a string trimmer assembly including a trimmer head rotatably driven by a drive shaft, the trimmer head defining a cavity, a spool supported in the cavity of the trimmer head and operable to support line to be dispensed, the spool including a through hole for receiving the line, the line dispensable though an opening in the trimmer head, a flange formed on the spool in a common plane with the opening and with the through hole, wherein the flange separates the line into a first line portion and a second line portion, wherein the first line portion is positioned on a first side of the flange and the second line portion is positioned on a second side of the flange.

The present disclosure provides, in another aspect, a string trimmer assembly including a trimmer head rotatably driven by a drive shaft, the trimmer head defining a cavity, a spool supported in the cavity of the trimmer head and operable to support line to be dispensed, the spool including a through hole for receiving the line, the line dispensable though an opening in the trimmer head, a first flange formed on the spool positioned adjacent an upper portion of the spool, a second flange formed on the spool positioned adjacent a lower portion of the spool, a third flange formed on the spool positioned between the first flange and the second flange adjacent an intermediate portion of the spool, at least a portion of the third flange positioned in a common plane with the opening and with the through hole, a first line space defined between the first flange and the intermediate flange, a second line space defined between the second flange and the intermediate flange, such that the third flange separates the first line space and the second line space.

The present disclosure provides, in yet another aspect, a trimmer head for use with a string trimmer assembly, the trimmer head including a top plate, a body, the body and the top plate defining a cavity, a spool supported in the cavity of the trimmer head and operable to support line to be dispensed, the spool including a through hole for receiving the line, the line dispensable though an opening in the trimmer head, a nut coupled to the spool, a retainer coupled to the body, the retainer configured to accommodate axial and rotational play between the spool and the body, and a flange formed on the spool in a common plane with the opening and with the through hole, the flange separating the line into a first line portion and a second line portion, wherein the first line portion is positioned on a first side of the flange and the second line portion is positioned on a second side of the flange, and wherein the body is bumpable against a surface to move the body axially toward the top plate and momentarily inhibit relative axial and rotational play between the top plate and the body, thereby rotating the spool relative to the body and dispensing additional line from the opening.

Features and aspects of the disclosure will become apparent by consideration of the following detailed description and accompanying drawings.

### BRIEF DESCRIPTION OF THE DRAWINGS

FIG. 1 is a perspective view of a string trimmer.

FIG. 2 is a perspective view of a trimmer head.

FIG. 3 is a partially exploded cross-sectional view of the trimmer head of FIG. 2.

FIG. 4 is an upper perspective view of a spool.

FIG. 5 is a cross-sectional perspective view of the spool of FIG. 4, taken through section line 5-5 of FIG. 4.

FIG. 6 is an enlarged cross-sectional view of the spool of FIG. 4, taken through section line 6-6 of FIG. 4.

Before any independent embodiments of the disclosure are explained in detail, it is to be understood that the invention is not limited in its application to the details of construction and the arrangement of components set forth in the following description or illustrated in the following drawings. The invention is capable of other independent embodiments and of being practiced or of being carried out in various ways. Also, it is to be understood that the phraseology and terminology used herein is for the purpose of description and should not be regarded as limiting.

### DETAILED DESCRIPTION

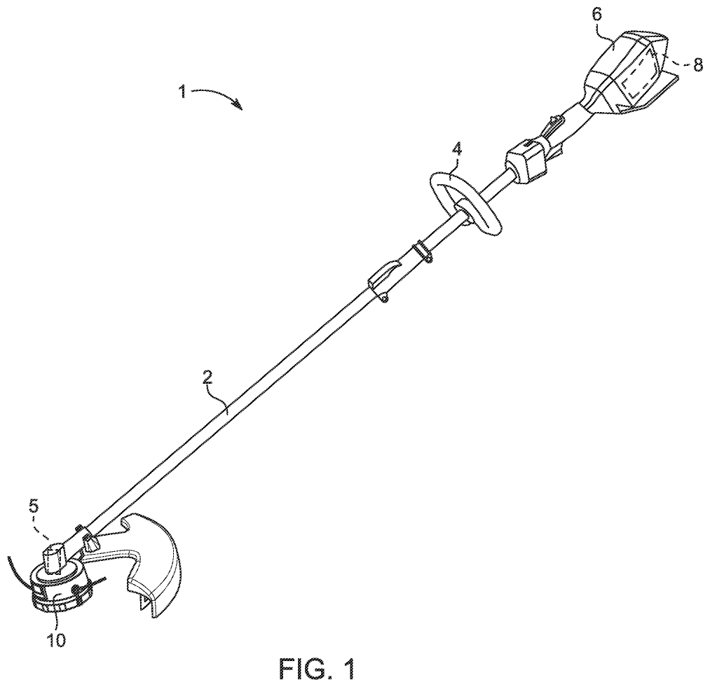

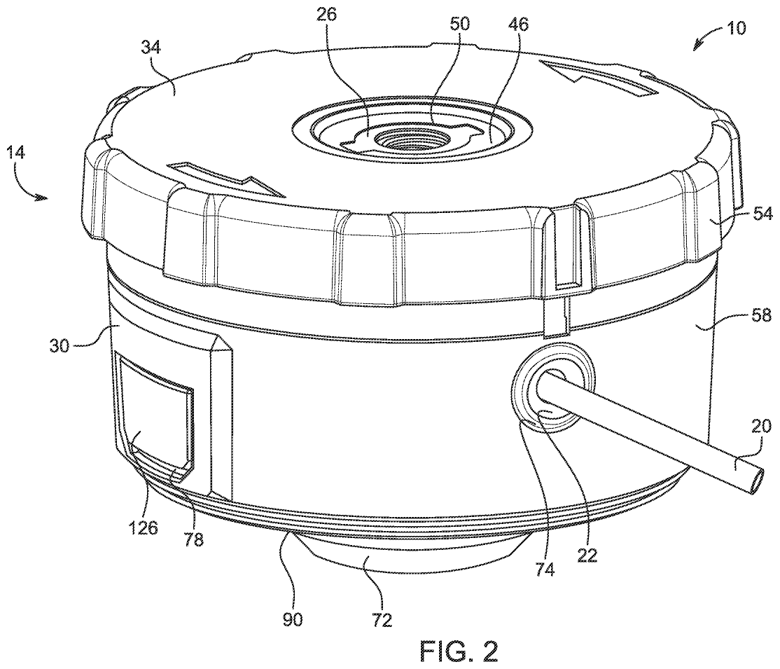

FIGS. 2-4 illustrate a trimmer head 10 for use on an example string trimming tool, such as a trimmer 1 (FIG. 1). As shown in FIG. 1, the trimmer 1 generally includes a shaft 2 with a handle 4 toward one end and a motor housing 6 enclosing an electric motor 8 with a motor-driven output, or drive shaft 5, for connection to a trimmer head 10 on the other end. Various powered trimmers (e.g., battery-powered, gas-powered, etc.) may be used with the trimmer head 10.

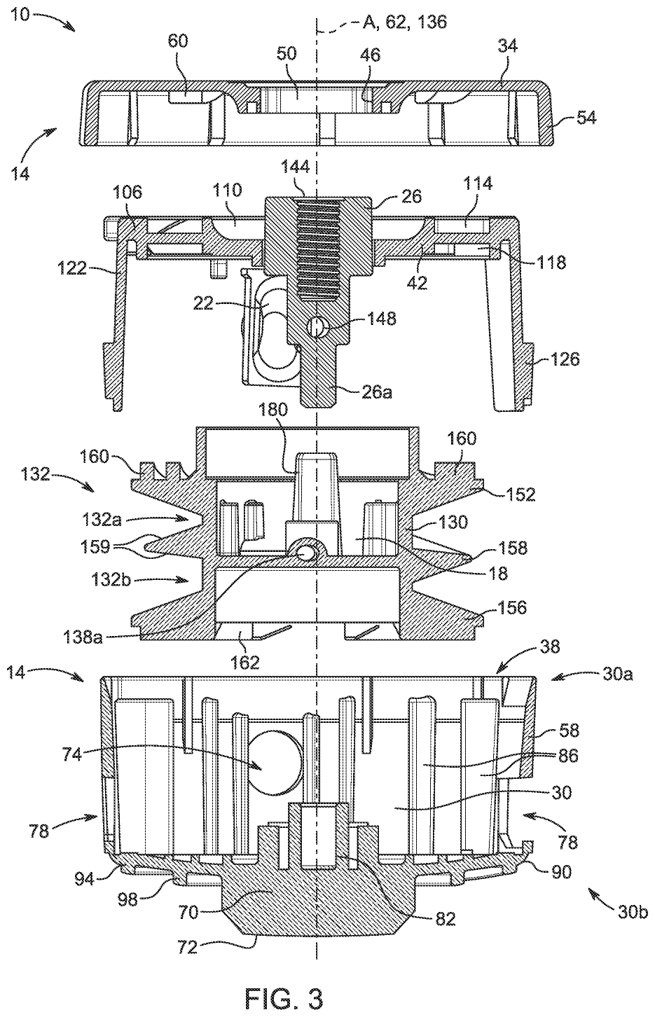

As shown in FIGS. 2 and 3, the trimmer head 10 includes a housing 14 rotatable about an axis A and a spool 18 (FIG. 3) for retaining one or more cutting lines 20. Cutting line 20 is wound around the spool 18 and extends through opposed eyelets 22 to cut vegetation (e.g., grass, weeds, etc.). In the illustrated embodiment, the trimmer head 10 is mounted to the drive shaft 5 via the spool 18. In other words, the spool 18 is drivingly connected to the drive shaft 5, and the trimmer head 10 is categorized as a “spool mounted trimmer head.” In particular, a nut, such as an insert molded nut 26, configured to be drivingly connected to the drive shaft may be insert molded into the spool 18.

In other embodiments, the trimmer head 10 is mounted to the drive shaft 5 via the housing 14, rather than via the spool 18. In such embodiments, a main body 30 and a top plate 34 of the housing 14 are rotatably and axially fixed to the drive shaft 5, and the trimmer head 10 is categorized as a “housing mounted trimmer head.”

Referring still to FIGS. 2 and 3, the housing 14 includes the main body 30 and the top plate 34. In some embodiments, the top plate 34 is and/or includes a cap. The top plate 34 is spaced above the spool 18 (FIG. 3) and is keyed to the insert molded nut 26. The spool 18 and the top plate 34 are thus fixed to one other via the insert molded nut 26 to rotate and axially move together. The main body 30 defines a cavity 38 for receiving the spool 18. A retainer ring, such as a retainer 42, is positioned at an upper end (e.g., the first end 30a) of the main body 30. The retainer 42 is located on the insert molded nut 26 and is captured with axial and rotational play between the top plate 34 and an upper end of the spool 18. A spring, such as a coil spring (not shown), is located at a lower end of the spool 18 to bias against a lower portion of the housing 14.

In the illustrated embodiment, the top plate 34 is generally cylindrical and includes a center boss 46 having an aperture 50 extending through the center boss 46. The aperture 50 is shaped and sized to fixedly receive the insert molded nut 26. An outer rim 54 of the top plate 34 covers an end of a sidewall 58 of the main body 30 to enclose the cavity 38. A series of teeth 60 are positioned on an inner surface of the top plate 34 and are engageable with a corresponding series of teeth 114 positioned on the retainer 42.

The main body 30 is generally cylindrical and includes a first end 30a, a second end 30b opposite the first end 30a, and a longitudinal axis 62 extending from the first end 30a to the second end 30b. The longitudinal axis 62 is collinear to the rotational axis A. The main body 30 additionally includes the sidewall 58, a base wall 70, and a protuberance/wear bump 72 positioned on the base wall 70. The sidewall 58 defines a pair of eyelet openings 74 and a pair of retainer openings 78. The eyelet openings 74 are shaped and sized to receive the eyelets 22, and the retainer openings 78 are shaped and sized to receive at least a portion of the retainer 42. An inner surface of the base wall 70 includes a center boss 82 and one or more ribs 86. The center boss 82 is shaped and sized to receive a portion of the insert molded nut 26. The ribs 86 axially extend from the base wall 70 and are configured to interface with the spool 18.

Referring still to FIGS. 2 and 3, the wear bump 72 may be a generally domed-shaped protuberance extending from the base wall 70 on the main body 30. The wear bump 72 provides a body or boss upon which a user may “bump” the trimmer head 10, and the wear bump 72 is further positioned on the main body 30 to prevent damage to the housing 14 of the trimmer head 10 during the “bumping” action. As will be described in greater detail below, during operation (e.g., a cutting operation) of the trimmer 1, the trimmer head 10 may be bumped against a work surface (e.g., “bumping” action) to dispense additional cutting line 20 from the spool 18 and through the eyelets 22.

With continued reference to FIGS. 2 and 3, an edge 90 is formed on an outer surface of the main body 30 at a junction between the sidewall 58 and the base wall 70. More specifically, the edge 90 is generally chamfered. The base wall 70 further includes a first wear ring 94 and a second wear ring 98. The first and second wear rings 94, 98 are generally circular and protrude from the base wall 70. In the illustrated embodiment, the wear bump 72 extends beyond the first and second wear rings 94, 98. In some embodiments, the wear bump 72 is reduced or omitted such that the first and second wear rings 94, 98 extend beyond the wear bump 72.

With reference to FIG. 3, the retainer 42 includes a ring 106 defining a central opening 110. The retainer 42 includes a first series of teeth 114 positioned on an upper surface of the ring 106, and a second series of teeth 118 positioned on a lower surface of the ring 106. The first series of teeth 114 are engageable with the teeth 60 positioned on the top plate 34 of the housing 14. Flexible retainer arms 122 extend from the ring 106, each having a retainer member 126 engageable in the associated retainer openings 78 to connect the main body 30 and the retainer 42.

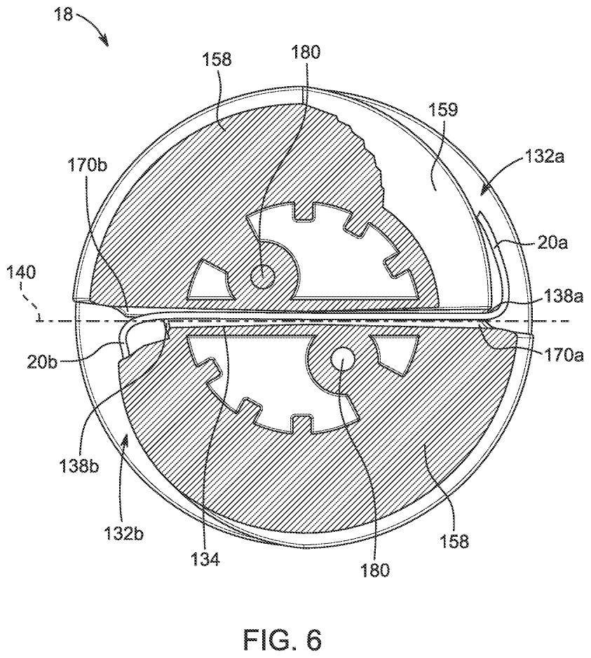

Referring now to FIGS. 3-6, the spool 18 includes a generally cylindrical, central body 130, core, arbor, or the like including a bore or spool post extending through at least a portion of the spool 18 along an axis 136 generally collinear to the longitudinal axis 62. A unitary tube 134 (e.g., through hole) extends between a first aperture 138a and a second aperture 138b such that the unitary tube 134 extends through the central body 130 for receiving cutting line 20. As specifically shown in FIG. 5, the first and second apertures 138a, 138b extend radially outwardly along an axis 140 (e.g., cutting plane), which, in some embodiments, is substantially perpendicular to the longitudinal axis 62. The spool 18 further includes a line receptacle or line spaces 132, (e.g., a first, or upper, line space 132a and a second, or lower, line space 132b) in which the cutting line 20 is received around the spool 18.

As best illustrated in FIGS. 5 and 6, the central body 130 defines one or more bores 180 that are shaped and sized to receive the insert molded nut 26 and/or one or more members connected thereto. In some embodiments, a single bore is centered along the longitudinal axis 62. In the illustrated embodiment, two bores 180 are positioned offset from the longitudinal axis 62. Other embodiments may include three or more bores. Referring back to FIG. 3, the insert molded nut 26 and/or one or more members connected thereto is positioned within the bore 180. The insert molded nut 26 includes a threaded opening 144 shaped and sized to receive the drive shaft 5 of the trimmer 1. In order to couple the trimmer head 10 to the drive shaft 5, the insert molded nut 26 is tightened around the drive shaft 5. In the illustrated embodiment, a distal end 26a of the insert molded nut 26 protrudes through the bores 180 and is received within the center boss 82 of the main body 30 of the housing 14. In other embodiments, the distal end 26a of the insert molded nut 26 protrudes at least partially into the spool 18. In some embodiments, the distal end 26a extends through a single central bore 180.

The insert molded nut 26 additionally includes an aperture 148 that extends through the insert molded nut 26 along an axis that may be generally perpendicular to the longitudinal axis 62. In some embodiments, the aperture 148 of the insert molded nut 26 aligns with the first and second apertures 138a, 138b of the spool 18, thereby forming a passageway for cutting line 20 to be fed through the housing 14, the spool 18, and the insert molded nut 26. In the illustrated embodiment, the spool 18 includes the unitary tube 134 extending between the first and second apertures 138a, 138b rather than a non-unitary or broken tube extending through multiple components. For embodiments incorporating a “housing mounted trimmer head,” the insert molded nut 26 may communicate with the spool 18 in a different way. In some embodiments incorporating a “housing mounted trimmer head,” the insert molded nut 26 and the spool 18 may not communicate at all.

The central body 130 of the spool 18 includes an upper first flange 152, a lower second 156, and an intermediate third flange 158 positioned between the first flange 152 and the second flange 156 and dividing the line spaces 132 into the upper line space 132a and the lower line space 132b. As better illustrated in FIGS. 5 and 6, the upper line space 132a is defined by an upper side of the third flange 158 and a lower side of the first flange 152. The upper line space 132a receives a first, upper cutting line portion 20a of the cutting line 20. The lower line space 132b is defined by a lower side of the third flange 158 and an upper side of the second flange 156 and receives a second, lower cutting line portion 20b of the cutting line 20. The first, second, and third flanges 152, 156, 158 are arranged in parallel planes in some embodiments. In other embodiments, one or more of the flanges (e.g., first, second, and third flanges 152, 156, 158) extend around the central body 130 along a helical path, for instance.

In some embodiments, the spool 18 may include additional flanges. Any or all of the flanges (e.g., first, second, and third flanges 152, 156, 158) may be planar, disc shaped, gear shaped, or another shape depending on a desired construction of the trimmer head 10. In the illustrated embodiment, as specifically shown in FIG. 5, the third flange 158 includes sloped edges 159 that extend radially outwardly from the central body 130 and toward one another and toward the cutting plane/axis 140.

Teeth 160 are formed on the first flange 152 and are selectively engageable with the second series of teeth 118 on the retainer 42. In the illustrated embodiment, teeth 162 are formed on the second flange 156. In some embodiments, the teeth 162 are selectively engageable with teeth or apertures formed on the main body 30. In other embodiments, the spool 18 may be received in the trimmer head 10 of the trimmer 1 in another orientation, or even in a trimmer head of another trimmer. In such embodiments, the teeth 160 and/or the teeth 162 of the spool 18 may engage portions of the trimmer head in which the spool 18 is received.

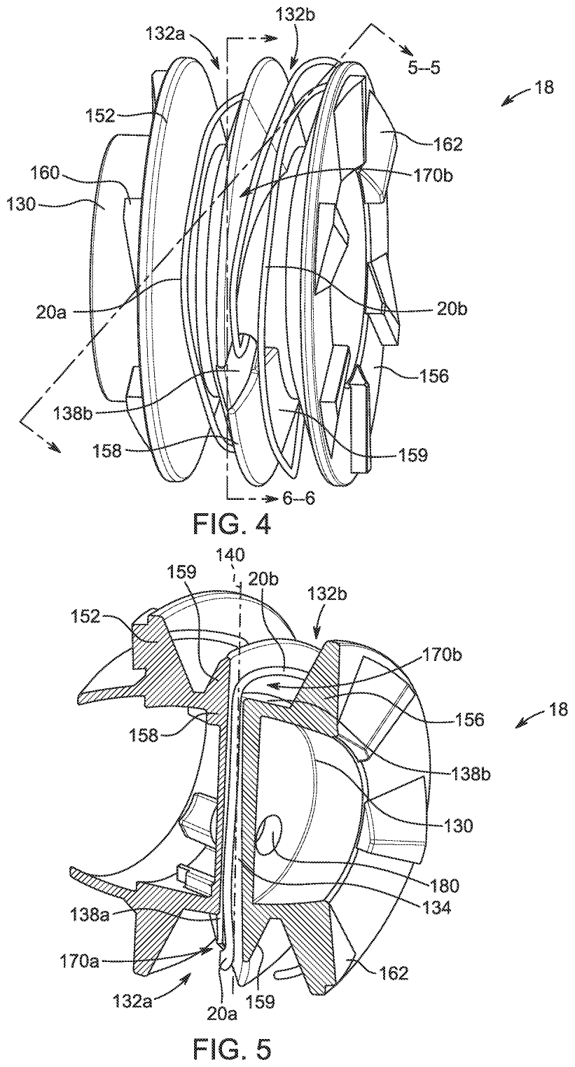

With specific reference to FIGS. 4-6, the third flange 158 at least partially surrounds the first and second apertures 138a, 138b and the unitary tube 134 such that the unitary tube 134 has radially opposite ends opening into the upper- and lower-line spaces 132a, 132b. More specifically, the first aperture 138a opens to the first line space 132a, and the second aperture opens to the second line space 132b, thereby defining portions of the cutting line 20 as first and second cutting line portions 20a, 20b. The first aperture 138a further opens/transitions into a first recess 170a or ramped relief surface formed in the sloped edge 159, and the second aperture 138b opens/transitions into a second recess 170b or ramped relief surface formed in the sloped edge 159. The recesses 170a, 170b accommodate a smooth or soft transition for the cutting line 20 between the unitary tube 134 and the respective upper- and lower-line spaces 132a, 132b.

Directing the cutting line 20 along two different paths at least partially partitioned from one another may lessen an amount that the cutting line 20 tangles, thereby reducing the amount of jams or other interruptions in operation caused by the cutting line 20 (e.g., tangled or caught cutting line 20, improper feeding of cutting line 20, cutting line 20 getting stuck within the trimmer head 10, etc.).

As best illustrated in FIG. 6, the first and second cutting line portions 20a, 20b are directed into different line receptacles (e.g., upper line space 132a, lower line space 132b) to continue wrapping around the spool 18 in a common rotational direction (e.g., clockwise). In some embodiments, the first and second cutting line portions 20a, 20b wrap around the spool 18 in opposite or otherwise different directions. In some embodiments, as more coils of cutting line 20 wrap around the spool 18, the ramped relief surfaces 170a, 170b force the coils of cutting line 20 to stay in an order in which coils of cutting line 20 were wrapped around the spool 18.

Stated another way, the third flange 158 and partitioned upper- and lower-line spaces 132a, 132b, in some embodiments, prevent coils of the cutting line 20 from overlapping and tangling. In some instances, this arrangement may prevent a coil of cutting line 20 from being pulled tight under a previous coil of cutting line 20 which may lead to a tangle. In some instances of severe or increased tangling, most or all of the cutting line 20 may need to be unwrapped/uncoiled (e.g., by a user). In such instances of severe tangling, the cutting line 20 may need to be re-wrapped/re-coiled around the spool 18. Stated another way, this arrangement may, in some embodiments, prevent the need for a user to completely remove the cutting line 20 from the spool 18 and start over with a new cutting line 20 or re-install a previously tangled cutting line 20.

Referring back to FIG. 3, a spring (not shown) is located at the lower end of the spool 18 to bias against the housing 14 (specifically, against a portion of the main body 30 in the illustrated embodiment). In the biased position, the retainer 42 and main body 30 are biased downwardly by the spring and the spool 18 is drivingly connected to the housing 14 via the second series of teeth 118 located on the lower surface of the retainer 42 cooperating with the teeth 160 on the first flange 152 of the spool 18.

To install cutting line 20, an end of a single cutting line 20 is fed through the passageway in one eyelet 22, into and through the first aperture 138a, through the unitary tube 134, and out of and through the second aperture 138b of the spool 18. The end of the cutting line 20 is then fed through the passageway in the other eyelet 22, such that an equal amount of line extends from each eyelet 22. The cutting line 20 is centered to define generally equal first and second cutting line portions 20a, 20b and then wound onto the spool 18 (e.g., by turning the housing 14 in a direction opposite to a feed direction while holding the top plate 34) until sufficient cutting line 20 extends from each eyelet 22. During installation of the cutting line 20, the spool 18 is wound to shorten an amount of cutting line 20 outside of the eyelets 22, thereby increasing an amount of cutting line 20 wound on the spool 18. As the spool 18 is wound, the first aperture 138a and first relief 170a direct the first cutting line portion 20a into the first line space 132a, and the second aperture 138b and second relief 170b direct the second cutting line portion 20b into second line space 132b, thereby defining portions of the cutting line 20 as substantially equal first and second cutting line portions 20a, 20b positioned in respective upper- and lower-line spaces 132a, 132b.

Stated another way, as the spool 18 is wound, the cutting line 20 is directed to opposite sides of the third flange 158 to reduce an amount of cutting line 20 in a single space, thereby reducing the likelihood of tangling of the line.

In operation, the trimmer 1 is operated to rotate the drive shaft 5 and, thereby, the spool 18. As mentioned above, in the biased, initial position, the housing 14 and the retainer 42 are biased downwardly via the biasing spring, and the spool 18 is drivingly connected to the housing 14 via the plurality of cooperating interfaces 118, 160 located on the retainer 42 and the top end of the spool 18. As a result, the trimmer 1 can be operated to rotate the drive shaft 5, thereby rotating the spool 18 (along with the housing 14 and the retainer 42) and the cutting line 20 so that the cutting line 20 may cut vegetation.

As the trimmer head 10 is being operated, the trimmer head 10 may be “bumped” against the work surface, for example, to dispense additional cutting line 20. The housing 14 and the retainer 42 move axially relative to the insert molded nut 26 against the spring bias to disengage the cooperating interfaces (e.g., teeth 160, 118) on the top of the spool 18 and the bottom of the retainer 42. With these cooperating interfaces 160, 118 disengaged, the housing 14 is free to rotate relative to the spool 18 so as to dispense additional cutting line 20. The housing 14 may be depressed until the retainer 42 engages the top plate 34. At this time, a plurality of cooperating interfaces (e.g., ramps, or teeth, 114 formed on the bottom of the top plate 34 and ramps, or teeth, 60 formed on the top of the retainer 42) engage with one another so as to momentarily drivingly connect the housing 14 with the spool 18. Once the housing 14 disengages the surface, the spring biases the housing 14 and the retainer 42 downwardly into the biased position. As the cooperating interfaces 114, 60 on the bottom of the top plate 34 and the top of the retainer 42 are disengaged, the housing 14 is again free to rotate relative to the spool 18 so as to dispense additional cutting line 20 until the cooperating interfaces 160, 118 on the top of the spool 18 and the bottom of the retainer 42 become engaged in the biased position.

Although aspects of the invention have been described in detail with reference to certain preferred constructions, variations and modifications exist within the scope and spirit of one or more independent aspects of the invention as described.

Various features of the disclosure are set forth in the following claims.

What is claimed is:

1. A string trimmer assembly comprising:
a trimmer head rotatably driven by a drive shaft, the trimmer head defining a cavity;
a spool supported in the cavity of the trimmer head and operable to support line to be dispensed, the spool including a through hole for receiving the line, the line dispensable though an opening in the trimmer head; and
a flange formed on the spool in a common plane with the opening and with the through hole;
wherein the flange separates the line into a first line portion and a second line portion; and
wherein the first line portion is positioned on a first side of the flange and the second line portion is positioned on a second side of the flange.

2. The string trimmer assembly of claim 1, wherein the flange includes a first ramped surface configured to direct the first line portion toward the first side of the flange.

3. The string trimmer assembly of claim 2, wherein the flange includes a second ramped surface configured to direct the second line portion toward the second side of the flange.

4. The string trimmer assembly of claim 3, wherein the first ramped surface and the second ramped surface are positioned on opposing sides of the spool adjacent the through hole.

5. The string trimmer assembly of claim 1, wherein the first line portion extends through a first portion of the through hole in a first direction, the first portion of the through hole positioned on a first side of the trimmer head, and wherein the second line portion extends through a second portion of the through hole in a second direction, the second portion of the through hole positioned on a second side of the trimmer head opposite the first side.

6. The string trimmer assembly of claim 5, wherein the first direction and the second direction are opposite one another.

7. The string trimmer assembly of claim 6, wherein the flange isolates the first line portion extending in the first direction from the second line portion extending in the second direction relative to an axial direction extending along an axis of the drive shaft.

8. The string trimmer assembly of claim 1, further comprising a housing, wherein the trimmer head is configured to be mounted to the drive shaft via the housing.

9. The string trimmer assembly of claim 1, wherein the trimmer head is configured to be mounted to the drive shaft via the spool.

10. A string trimmer assembly comprising:
a trimmer head rotatably driven by a drive shaft, the trimmer head defining a cavity;
a spool supported in the cavity of the trimmer head and operable to support line to be dispensed, the spool including a through hole for receiving the line, the line dispensable though an opening in the trimmer head;
a first flange formed on the spool positioned adjacent an upper portion of the spool;
a second flange formed on the spool positioned adjacent a lower portion of the spool;
a third flange formed on the spool positioned between the first flange and the second flange adjacent an intermediate portion of the spool, at least a portion of the third flange positioned in a common plane with the opening and with the through hole;
a first line space defined between the first flange and the intermediate flange; and
a second line space defined between the second flange and the intermediate flange, such that the third flange separates the first line space and the second line space.

11. The string trimmer assembly of claim 10, wherein the third flange directs a first line portion of the line in to the first line space.

12. The string trimmer assembly of claim 11, wherein the third flange directs a second line portion of the line in to the second line space.

13. The string trimer assembly of claim 12, wherein the first line portion extends through a first portion of the through hole in a first direction, the first portion of the through hole positioned on a first side of the spool, and wherein the second line portion extends through a second portion of the through hole in a second direction, the second portion of the through hole positioned on a second side of the spool opposite the first side.

14. The string trimmer assembly of claim 13, wherein the first direction and the second direction are opposite one another.

15. The string trimmer assembly of claim 12, wherein the third flange includes a first ramped surface configured to direct the first line portion toward the first flange.

16. The string trimmer assembly of claim 15, wherein the third flange includes a second ramped surface configured to direct the second line portion toward the second flange.

17. The string trimmer assembly of claim 16, wherein the first ramped surface and the second ramped surface are positioned on opposing sides of the spool adjacent the through hole.

18. The string trimmer assembly of claim 10, further comprising a housing, wherein the trimmer head is configured to be mounted to the drive shaft via the housing.

19. The string trimmer assembly of claim 10, wherein the trimmer head is configured to be mounted to the drive shaft via the spool.

20. A trimmer head for use with a string trimmer assembly, the trimmer head comprising:
a top plate;
a body, the body and the top plate defining a cavity;
a spool supported in the cavity of the trimmer head and operable to support line to be dispensed, the spool including a through hole for receiving the line, the line dispensable though an opening in the trimmer head;
a nut coupled to the spool;
a retainer coupled to the body, the retainer configured to accommodate axial and rotational play between the spool and the body; and
a flange formed on the spool in a common plane with the opening and with the through hole, the flange separating the line into a first line portion and a second line portion, wherein the first line portion is positioned on a first side of the flange and the second line portion is positioned on a second side of the flange, and
wherein the body is bumpable against a surface to move the body axially toward the top plate and momentarily inhibit relative axial and rotational play between the top plate and the body, thereby rotating the spool relative to the body and dispensing additional line from the opening.
